(19) United States
(12) Patent Application Publication
(10) Pub. No.: US 2011/0195277 A1
(43) Pub. Date: Aug. 11, 2011

(54) HIGH DENSITY MAGNETIC RECORDING MEDIUM AND MANUFACTURING METHOD THEREOF

(75) Inventors: Tetsuya Osaka, Shinjuku-ku (JP); Atsushi Sugiyama, Shinjuku-ku (JP); Takuma Hachisu, Shinjuku-ku (JP); Shuichi Shoji, Shinjuku-ku (JP); Jun Mizuno, Shinjuku-ku (JP); Hiroshi Sakai, Ichihara-shi (JP)

(73) Assignees: WASEDA UNIVERSITY, Tokyo (JP); SHOWA DENKO K.K., Tokyo (JP)

(21) Appl. No.: 12/967,508

(22) Filed: Dec. 14, 2010

(30) Foreign Application Priority Data
Jan. 14, 2010 (JP) 2010-005534
Dec. 3, 2010 (JP) 2010-269983

(51) Int. Cl. G11B 5/706; G11B 5/842; B05D 3/00; B05D 5/00

(52) U.S. Cl. 428/846; 427/271; 427/198; 977/773; 977/888

(57) ABSTRACT

A high density magnetic recording medium including aggregates of magnetic nanoparticles arranged stably and efficiently in demarcated sections in the surface of a substrate is manufactured by the steps of forming a plurality of parallel tracks in the surface of the substrate, forming a plurality of minute recesses serially at approximately equal intervals in each of the tracks, casting a liquid dispersion of magnetic nanoparticles into the minute recesses, and evaporating dispersing medium from the liquid dispersion, thereby forming an aggregate of magnetic nanoparticles in each of the minute recesses.

### BACKGROUND OF THE INVENTION

1. Technical Field

The present invention relates to a high density magnetic recording medium which will help realize a high density magnetic recording system and also relates to a manufacturing method thereof.

2. Background Art

Information storage by magnetic recording is a fundamental technology to support the recent advanced information society. Increase in magnetic recording density contributes to efficient processing of a large amount of information and helps utilize intellectual properties in the society. It also contributes to miniaturization and weight reduction of recording devices, which in turn promote ubiquitous computing and help reduce loads on environment through power saving and material saving. The current hard disk drive (HDD) employs the magnetic recording medium having a magnetic thin film formed by sputtering. For the recording medium to have a higher areal recording density, each recording bit should be small in area and stable for a long period of time. Reduction technique of the area of each recording bit means technique which is accomplished by miniaturizing the magnetic particles constituting the magnetic thin film.

Miniaturization of magnetic particles is accompanied by thermal disturbance which makes recorded information unstable to heat. Thermal disturbance occurs when the energy defined by KᵤV (Kᵤ: uniaxial crystal magnetic anisotropy constants, V: volume of magnetic particle) to keep the direction of magnetization in the particle, which is proportional to the volume, is smaller than the thermal energy defined by k_{B}T (k_{B}: Boltzmann constant, T: temperature (in K) for use). Thus, thermal disturbance is a limiting factor to miniaturization of magnetic particles. One desired way to reduce thermal disturbance is to use a material which has a high crystal magnetic anisotropy constant (Kᵤ) for stable recording bits as a material for a magnetic recording medium.

To achieve the foregoing object, the present inventors proposed (in JP-A 2009-035769) a method for producing and arranging FePt nanoparticles having a uniform shape, particle diameter, and magnetic property. The nanoparticles having a uniform shape, particle diameter, and magnetic property are not enough to realize a magnetic recording medium that permits the nanoparticles to fully exhibit their characteristic properties. Thus, it is indispensable to develop a new technology to arrange magnetic nanoparticles efficiently in a stable manner on the substrate.

An additional related art is disclosed in JP-A 2006-291303.

### SUMMARY OF THE INVENTION

The present invention was completed in view of the foregoing. It is an object of the present invention to provide a high density magnetic recording medium which has magnetic nanoparticles stably arranged in minute sections formed in the surface of a substrate. It is another object of the present invention to provide a method for efficiently manufacturing the high density magnetic recording medium.

In order to achieve the foregoing object, the present inventors carried out a series of researches which led to a finding that the desired high density magnetic recording medium can be obtained by forming a plurality of parallel tracks in the surface of a substrate, forming in each track a plurality of minute recesses arranged serially at approximately equal intervals, and finally forming an aggregate of magnetic nanoparticles in each minute recess. Moreover, it was also found that the aggregates of magnetic nanoparticles can be formed by casting a liquid dispersion of magnetic nanoparticles into the minute recesses and then evaporating dispersing medium from the liquid dispersion.

It was also found that the aggregates of magnetic nanoparticles bind to the inner surface of the minute recesses if the inner surface of the minute recesses is coated with a mono layer of an organic compound having a functional group (at one end of its molecule) which binds to the inner surface and another functional group (at the other end of its molecule) which does not bind to the inner surface but binds to the magnetic nanoparticles or a coupling agent attached to the magnetic nanoparticles. It was also found that the aggregates of magnetic nanoparticles can be formed efficiently if the substrate surface including the inner surface of the minute recesses is coated with a monomolecular layer of an organic compound having a functional group (at one end of its molecule) which binds to the inner surface and another functional group (at the other end of its molecule) which does not bind to the inner surface but binds to the magnetic nanoparticles or a coupling agent attached to the magnetic nanoparticles, so that the magnetic nanoparticles bind to the substrate surface including the inner surface of the minute recesses, and then the magnetic nanoparticles bonding to the surface other than the inner surface of the minute recesses are removed. Then, the magnetic nanoparticles easily peel off from the substrate surface but those in the minute recesses bind to the inner surface and are protected by the minute recesses. In this way it is possible to efficiently arrange the aggregates of magnetic nanoparticles only in the minute recesses which are limited in volume without complicated handling to load magnetic nanoparticles directly and selectively into the minute recesses. Accordingly, the present inventors found a method for efficiently manufacturing the high density magnetic recording medium which enables to realize high density magnetic recording systems for next generation. The foregoing findings are the basis of the present invention.

The first aspect of the present invention is directed to a high density magnetic recording medium including aggregates of magnetic nanoparticles arranged in demarcated sections in the surface of a substrate, which is characterized in that the substrate includes a plurality of parallel tracks formed in the surface thereof, each of the tracks includes minute recesses serially formed therein at approximately equal intervals, and each of the minute recesses includes an aggregate of magnetic nanoparticles.

The high density magnetic recording medium according to the present invention should preferably be one which is produced in such a way that the aggregates of magnetic nanoparticles are formed by casting a liquid dispersion of magnetic nanoparticles into the minute recesses and subsequently evaporating dispersing medium from the liquid dispersion.

The second aspect of the present invention is directed to a manufacturing method of a high density magnetic recording medium including aggregates of magnetic nanoparticles arranged in demarcated sections in the surface of a substrate. This method includes the steps of: forming a plurality of parallel tracks in the surface of the substrate, forming a plurality of minute recesses serially at approximately equal intervals in each of the tracks, casting a liquid dispersion of magnetic nanoparticles into the minute recesses, and evaporating dispersing medium from the liquid dispersion, thereby forming an aggregate of magnetic nanoparticles in each of the minute recesses.

The manufacturing method of a high density magnetic recording medium according to the present invention should preferably be one which is characterized in that the tracks are formed by grooving, and the minute recesses are formed individually in the groovelike tracks.

In addition, the method according to the present invention should preferably be one which is characterized in that the method includes the steps of: forming a monomolecular layer of an organic coating agent on an inner surface of the minute recesses, the organic coating agent having a functional group at one end of its molecule which binds to the inner surface and another functional group at the other end of its molecule which does not bind to the inner surface but binds to the magnetic nanoparticles; and bonding the magnetic nanoparticles to the functional group of the other end, thereby binding the magnetic nanoparticles to the inner surface of the minute recesses.

In this case, the method according to the present invention should preferably be one which is characterized in that the method includes the steps of: forming a monomolecular layer of an organic coating agent on the substrate surface including an inner surface of the minute recesses, thr organic coating agent having a functional group at one end of its molecule which binds to the inner surface and another functional group at the other end of its molecule which does not bind to the inner surface but binds to the magnetic nanoparticles; bonding the magnetic nanoparticles to the functional group of the other end, thereby binding the magnetic nanoparticles to the substrate surface including the inner surface of the minute recesses; and subsequently removing the magnetic nanoparticles binding to the surface other than the inner surface of the minute recesses.

Moreover, according to the present invention, each of the minute recesses should preferably have an opening diameter of 20 to 500 nm and a depth of 10 to 500 nm, and the magnetic nanoparticles should preferably have an average particle diameter of 3 to 20 nm, a coercive force being not less than 237 kA/m, and a remanence ratio being not less than 0.5.

The present invention provides a manufacturing method of a high density magnetic recording medium by stably and efficiently arranging aggregates of magnetic nanoparticles in demarcated sections formed in the surface of a substrate.

The high density magnetic recording medium will help realize high density magnetic recording systems.

### BRIEF DESCRIPTION OF THE DRAWINGS

FIG. 1 is a perspective view showing an example of the substrate suitable for the high density magnetic recording medium according to the present invention;

FIGS. 2A to 2G are diagrams illustrating one example of the process for forming minute recesses in the surface of the substrate by the nano-imprint method;

FIGS. 3A to 3D are diagrams illustrating one example of the process for forming aggregates of magnetic nanoparticles in the minute recesses in the substrate;

FIGS. 4A to 4E are diagrams illustrating another example of the process for forming aggregates of magnetic nanoparticles in the minute recesses in the substrate;

FIG. 5 is a partial perspective view showing an example the of the high density magnetic recording medium according to the present invention; and

FIGS. 6A to 6C are photographic images (taken by a field emission electron microscope) which shows the surface of the substrate used in Example, FIG. 6A is an image of the substrate which was taken before aggregates of FePt magnetic nanoparticles were formed, FIG. 6B is an image of the substrate which was taken after aggregates of FePt magnetic nanoparticles were formed, and FIG. 6C is a partly enlarged image of FIG. 6B.

### DETAILED DESCRIPTION OF THE PREFERRED EMBODIMENTS

The high density magnetic recording medium according to the present invention has aggregates of magnetic nanoparticles placed individually in demarcated sections formed in the surface of a substrate. There are a large number of minute recesses formed and arranged in the surface of the substrate supporting magnetic bodies. These minute recesses are formed apart from one another at certain intervals. They individually receive the aggregates of magnetic nanoparticles formed therein, so that the aggregates of magnetic nanoparticles are arranged separately in the surface of the substrate. Moreover, in the surface of the substrate are a plurality of tracks parallel to one another, each track having a plurality of minute recesses formed serially at approximately equal intervals.

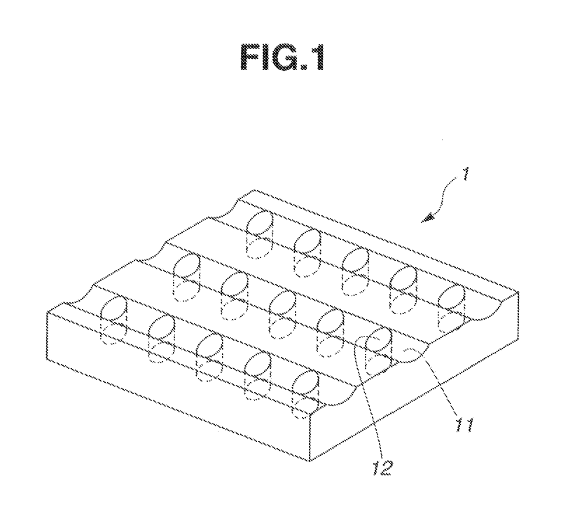

The substrate has a plurality of parallel tracks formed in the surface thereof. Each track has a plurality of minute recesses serially formed therein, which are apart from one another at approximately equal intervals. In the surface of the substrate, a plurality of tracks are provided parallel to one another, each track having a plurality of minute recesses formed serially at approximately equal intervals. An example of the substrate in such a structure is shown in FIG. 1. The illustrated substrate has parallel groovelike tracks 11 (each having a cross section of circular arc) which are formed in the upper part of the substrate 1. Each track has discrete minute recesses 12 which are formed at approximately equal intervals in the lengthwise direction thereof. A portion of the substrate shown in FIG. 1 has three tracks 11, each having five recesses 12. Hence there are 15 recesses in total. It is a mere example, and an actual substrate for high density magnetic recording has a large number of tracks and a large number of minute recesses.

The substrate may be formed from a variety of materials, such as silicon, silicon oxide, quartz glass, amorphous glass, aluminum, and aluminum oxide, with silicon being preferable.

The tracks may be formed by any known method, such as nano imprinting and photolithography with electron rays. Incidentally, although the substrate shown in FIG. 1 has groovelike tracks and the minute recesses are formed in them, the tracks do not need to be concave but they may be flat (flush with the surface) or convex (projecting from the surface).

The tracks may have any shape and size according to the intended use. For example, they may have a width of 20 to 500 nm, preferably 20 to 150 nm, and they may be 40 to 1000 nm, preferably 40 to 200 nm, apart from one another.

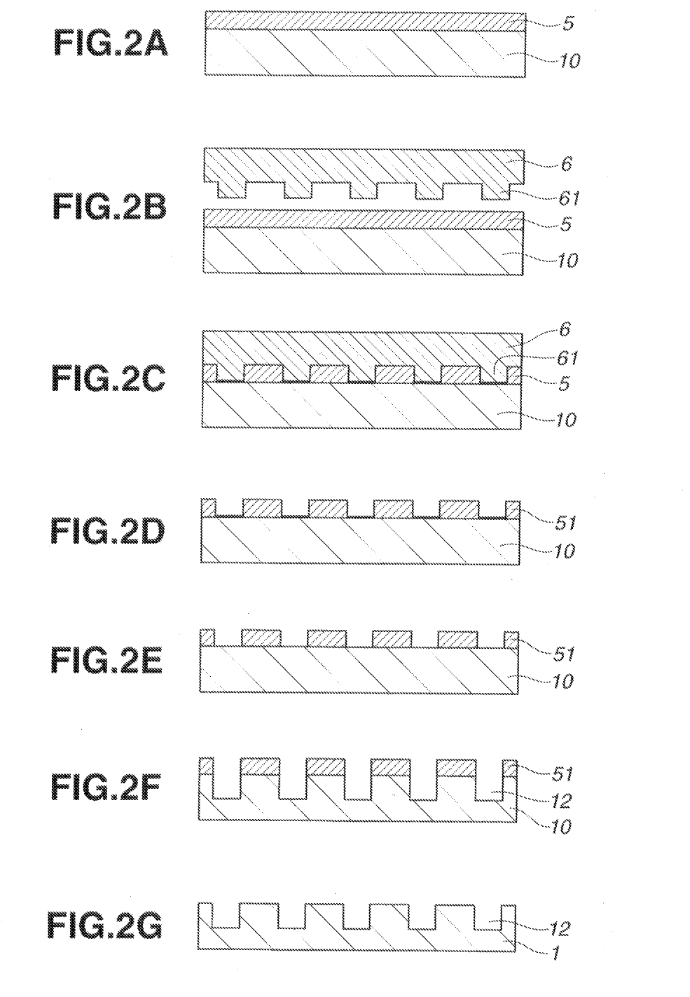

The minute recesses should preferably be formed by nano imprinting. The process of nano imprinting is illustrated in FIG. 2, which is a longitudinal sectional view. The first step shown in FIG. 2A is to apply, by spin coating or the like, an uncured resin composition 5 onto the top of the substrate 10 formed from silicon or the like. The resin composition should preferably be a UV-curable one. The subsequent step shown in FIG. 2B is to press a mold 6 against the resin composition 5 which has been applied to the top of the substrate 10. The mold 6 has projecting parts 61 which are so arranged as to coincide with the positions where the minute recesses are to be formed. In the subsequent step shown in FIG. 2C, the mold 6 is lowered so that the projecting parts 61 come close to or come into contact with the top of the substrate 10. With this state held still, the resin composition 5 is cured. In the case where a UV-curable resin composition is used, it is desirable to form the mold from quartz glass or the like which is transparent to UV light.

In the subsequent step shown in FIG. 2D, the mold 6 is removed, with the cured resin layer 51 remaining on those parts where the minute recesses are not formed. The thin resin layer remaining on those parts where the minute recesses are to be formed later is removed by anisotropic dry etching with oxygen plasma or the like, so that the surface of the substrate 10 is exposed.

The substrate 10 which has undergone the foregoing steps has exposed parts (where the minute recesses are to be formed) and resin-coated parts (where the minute recesses are not formed), as shown in FIG. 2E. In the subsequent step, the substrate 10 undergoes anisotropic dry etching with SF₆, so that the minute recesses 12 are formed therein, as shown in FIG. 2F. Finally, the resin layer 51 is peeled off. In this way, there is obtained the substrate 1 which has the minute recesses 12 formed therein, as shown in FIG. 2G.

The minute recesses may have any shape and size according to the intended use. Their opening (or maximum width) should preferably be 20 to 500 nm, particularly 20 to 100 nm, and their depth should preferably be 10 to 500 nm, particularly 10 to 50 nm, and most desirably 10 to 20 nm.

The magnetic nanoparticles used in the present invention are not specifically restricted so long as they are those of ferromagnetic material such as FePt and CoPt. They should preferably have an average particle diameter of 3 to 20 nm, particularly 4 to 10 nm, and most desirably 5 to 7 nm (in terms of primary particles). Incidentally, the average particle diameter may be calculated from an electron microgram taken by a transmission electron microscope (TEM) or the like.

The magnetic nanoparticles and their manufacturing method which are used in the present invention are not specifically restricted. They are disclosed in JP-A 2009-035769, for example.

Magnetic nanoparticles of FePt may be prepared by the following method which includes of:

allowing a solvent solution containing a Pt compound, a reducing agent, and a first dispersant to undergo reduction reaction for nuclear particles of metallic Pt to form (step a),

incorporating the solvent solution, in which nuclear particles of metallic Pt have formed, with an Fe compound and a second dispersant (preferably sequentially) for metallic Fe to precipitate on the nuclear particles of metallic Pt (step b), and

aging the resulting nanoparticles composed of Pt and Fe in the reaction solution at 185 to 320° C., preferably 225 to 275° C., and most desirably 245 to 255° C. (step c).

The foregoing three steps (a, b, and c) will be described below in more detail.

Step a is intended to form nuclear particles of metallic Pt by reduction reaction from a solvent solution containing a Pt compound, a reducing agent, and a first dispersant. The Pt compound includes, for example, Pt acetylacetonate and Pt ethoxide (Pt(OEt)₂). The reducing agent includes, for example, C₁₆₋₁₈ unsaturated hydrocarbons (preferably linear ones or those having a double bond at one terminal), such as 1-octadecene, and C₁₆₋₁₈ saturated hydrocarbon diols (preferably those in which the saturated hydrocarbon group is linear or those which have hydroxyl groups at 1- and 2-positions), such as 1,2-hexadecanediol.

The first dispersant should preferably be one which prevents coagulation of metallic Pt (resulting from reduction). It includes, for example, C₃₋₁₇ linear unsaturated fatty acids (such as oleic acid) and N-2-vinylpyrrolidone.

The first dispersant for the Pt compound and reducing agent is used in the form of solution in a solvent. The solvent should preferably be an organic solvent selected from ethers (such as benzylether and octylether), glycols (such as tetraethylene glycol), and C₁₈₋₂₀ saturated hydrocarbons (such as nonadecane).

The solvent solution should contain the Pt compound in a concentration of 0.45 to 0.65 mmol/dm³, preferably 0.50 to 0.55 mmol/dm³ (in terms of Pt). The solvent solution should contain the reducing agent in a concentration of 1.2 to 1.8 mmol/dm³, preferably 1.5 to 1.6 mmol/dm³. The solvent solution should contain the first dispersant in a concentration of 0.90 to 1.5 mmol/dm³, preferably 1.0 to 1.2 mmol/dm³.

The solvent solution containing the Pt compound, the reducing agent, and the first dispersant is heated at 60 to 275° C., particularly 80 to 100° C. (optionally with stirring), so that Pt ions originating from the Pt compound are reduced by the reducing agent into nucleic particles of metallic Pt. Duration of this reaction should preferably be 5 to 10 minutes. Although the reduction reaction gives rise to nucleic particles of metallic Pt, but it may not change the Pt compound (in the form of ions) entirely into nucleic particles of metallic Pt but allow part of it to remain unreduced. The Pt compound (or Pt ions) remaining unreduced may deposit in the form of metallic Pt in the subsequent steps.

Step b is intended to incorporate the solvent solution, which has undergone Step a for precipitation of nucleic particles of metallic Pt, with an Fe compound and a second dispersant (altogether at the same time, or preferably, sequentially), so that metallic Fe precipitates on the nucleic particles of metallic Pt. The Fe compound includes, for example, iron carbonyl, iron acetylacetonate, and iron ethoxide.

The second dispersant should preferably be one which prevents coagulation of metallic Fe (which has deposited). It includes, for example, C₁₆₋₁₈ linear unsaturated aliphatic amines, such as oleylamine.

The solvent solution should contain the Fe compound in a concentration of 0.95 to 1.15 mmol/dm³, preferably 0.99 to 1.09 mmol/dm³ (in terms of Fe). Also, the solvent solution should contain the second dispersant in a concentration of 0.90 to 1.5 mmol/dm³, preferably 1.0 to 1.2 mmol/dm³. The solvent solution containing the Fe compound and the second dispersant is heated at 100 to 240° C., particularly 115 to 125° C. (optionally with stirring), so that metallic Fe deposits on the nucleic particles of metallic Pt. Duration of this reaction should preferably be 5 to 15 minutes. Although this step causes metallic Fe to deposit, but it may not change the Fe compound entirely into metallic Fe but allow part of it to remain unreduced. The Fe compound remaining unreduced may deposit in the form of metallic Fe in the subsequent steps.

Step c is intended for the aging of nanoparticles containing Pt and metallic Fe (which has deposited on Pt) in the reaction solution at 185 to 320° C., preferably 225 to 275° C., most desirably 245 to 255° C. This aging causes Pt atoms and Fe atoms to diffuse into each other to form FePt nanoparticles (in the form of alloy of Pt and Fe). Duration of the aging should be 30 to 300 minutes, preferably 110 to 130 minutes. Shortage of time for aging may cause insufficient diffusion, while excessively long aging may result in coagulation of FePt nanoparticles.

Incidentally, the foregoing steps a to c should preferably be carried out in a reducing atmosphere composed of inert gas (such as argon and nitrogen), or the inert gas and hydrogen (a few percent) so as to prevent oxidation.

After aging, the reaction solution undergoes solvent exchange so that it is turned into a dispersion liquid containing magnetic nanoparticles. Alternatively, the reaction solution undergoes filtration in the usual way, so that the resulting FePt particles are deposited, and then the deposited FePt particles are dispersed into a solvent with the help of a dispersing medium. Centrifugal separation of FePt nanoparticles from the solution will help remove extremely fine particles by the action of solvent to coagulate and redisperse the FePt nanoparticles. In this way it is possible to obtain FePt nanoparticles uniform in particle diameter. Moreover, if necessary, the magnetic nanoparticles undergo surface treatment with a coupling agent which has at one end of the molecule functional groups binding to the magnetic nanoparticles and at the other end (distant side from the magnetic nano particle) of the molecule functional groups binding to the organic coating agent (to be mentioned later).

The alloyed FePt nanoparticles may undergo annealing at not less than 400° C., preferably not less than 500° C., more preferably not less than 550° C., and most desirably not less than 600° C. Although the annealing temperature is not specifically restricted in the upper limit, it should be not more than 900° C., preferably not more than 800° C., more preferably not more than 700° C., and most desirably not more than 650° C. The annealing should preferably be carried out in a reducing atmosphere composed of inert gas (such as argon and nitrogen), or the inert gas and hydrogen (1 to 5 vol %, particularly 2 to 3 vol %) in inert gas (such as argon and nitrogen). Duration of annealing should be 0.5 to 10 hours, particularly 2.5 to 3.5 hours. The annealing may also be carried out after the FePt nanoparticles have been placed on the substrate, especially in the minute recesses.

Incidentally, the FePt nanoparticles should preferably contain Fe and Pt in an atomic ratio (Fe:Pt) of from 50:50 to 60:40. This ratio is approximate to the ratio of Fe to Pt in an Fe—Pt alloy of face-centered tetragonal structure (Ll₀). Such FePt nanoparticles are desirable because of their high magnetic anisotropy and hence their strong magnetism.

The magnetic nanoparticles should preferably be ones which have a coercive force not less than 237 kA/m (3 kOe), particularly 395 to 474 kA/m (5 to 6 kOe), and a remanence ratio not less than 0.5, particularly 0.6 to 0.9.

The minute recesses formed in the substrate are given the liquid dispersion of the magnetic nanoparticles by casting. Subsequently, the liquid dispersion cast into the minute recesses is evaporated, so that the magnetic nanoparticles form aggregates in the minute recesses. To be more specific, the magnetic nanoparticles are dispersed into a dispersing medium such as toluene and hexane, and the resulting liquid dispersion is dripped into the minute recesses using pico-litter pipettes or inkjet method, and finally the dispersing medium is evaporated at 20 to 40° C.

Prior to the foregoing step, the inner surface of the minute recesses should preferably be coated with a monomolecular layer of an organic coating agent which has functional groups (at one end of the molecular chain) binding to the inner surface of the minute recesses and also has functional groups (at the other end of the molecular chain) binding to the magnetic nanoparticles or the coupling molecules chemically connected to the magnetic nanoparticles. In this way the magnetic nanoparticles can be bound to the inner surface of the minute recesses.

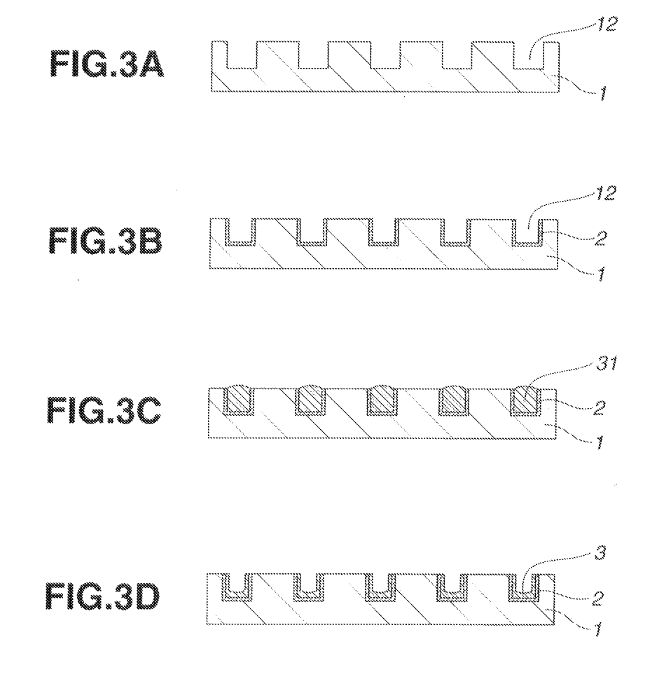

The foregoing process includes forming the minute recesses 12 in the surface of the substrate 1, as shown in FIG. 3A, coating the inner surface of the minute recesses 12 with the monomolecular layer 2 of an organic coating agent, as shown in FIG. 3B, filling the minute recesses 12 with the liquid dispersion 31 containing magnetic nanoparticles, as shown in FIG. 3C, and evaporating dispersing medium from the liquid dispersion 31, thereby forming the aggregates of magnetic nanoparticles in the minute recesses, as shown in FIG. 3D. In this way there is obtained the high density magnetic recording medium as desired. According to the present invention, aggregates of the magnetic nanoparticles may form like a thin layer on the inner surface of the minute recesses, and hence the magnetic nanoparticles are arranged at intervals of 1 to 20 nm, particularly 5 to 15 nm, in each aggregate thereof.

As mentioned above, the functional group at one end of the molecular chain of the organic coating agent is capable of binding to the inner surface of the minute recesses (or the substrate). In the case of a substrate for vertical magnetic recording which usually has a soft magnetic underlying layer (SUL) or an intermediate layer of silicon oxide (SiO₂) under the magnetic recording layer, the functional group should preferably be one which is capable of binding to such underlying layers. Examples of the functional group include alkoxysilanyl group (such as methoxysilanyl group and ethoxysilanyl group), silanol group, and hydroxyl group.

By contrast, the functional group at the other end of the molecular chain of the organic coating agent includes, for example, thiol group, amino group, cyano group, carboxyl group, hydroxyl group, alkoxysilanyl group (such as methoxysilanyl group and ethoxysilanyl group), silanol group, and hydroxyl group.

The organic coating agent mentioned above includes, for example, 3-mercaptopropyltrimethoxysilane, 3-mercaptopropyltriethoxysilane, 3-aminopropyltrimethoxysilane, and 3-aminopropyltriethoxysilane.

There are several methods for forming the monomolecular layer of the organic coating agent on the inner surface of the minute recesses. For example, one of them includes dissolving the organic coating agent in a solvent (such as toluene and hexane), dripping the resulting solution into the minute recesses using pico-litter pipettes or inkjet method, and evaporating the solvent at 20 to 60° C. (particularly 20 to 40° C.) for 10 to 60 minutes. Thus, the organic coating agent forms its monomolecular layer that chemically binds to the inner surface of the minute recesses through the functional group at one end of the molecular chain thereof.

Subsequently, the minute recesses (which have their inner surface coated with the monomolecular layer of the organic coating layer) are filled with the liquid dispersion of the magnetic nanoparticles and then the solvent of the liquid dispersion is evaporated. Thus, the magnetic nanoparticles are bound to the inner surface of the minute recesses through the functional group (at the other end of the molecular chain of the organic coating agent) which reacts with the surface of the magnetic nanoparticles or the functional group of the coupling molecule on the magnetic nanoparticles.

According to one preferable method, the aggregates of the magnetic nanoparticles are formed as follows. The substrate surface including the inner surface of the minute recesses is coated with a monomolecular layer of an organic coating agent having a functional group (at one end of its molecule) which chemically binds to the substrate surface and another functional group (at the other end of its molecule) which does not chemically bind to the substrate surface but chemically binds to the magnetic nanoparticles or the coupling molecules attached to the magnetic nanoparticles, so that the magnetic nanoparticles bind to the substrate surface including the inner surface of the minute recesses, and then the magnetic nanoparticles binding to the surface other than the inner surface of the minute recesses are removed.

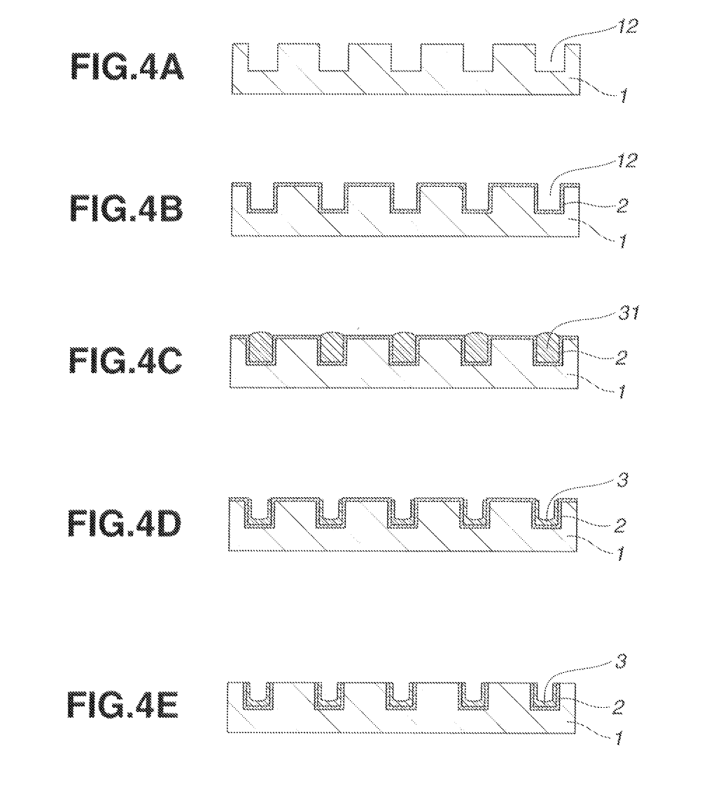

To be more specific, the foregoing steps are carried out as follows. First, the substrate 1 has the minute recesses 12 formed in the upper surface thereof, as shown in FIG. 4A. Next, the upper surface of the substrate 1, which includes the inner surface of the minute recesses 12, is coated with a monomolecular film 2 of an organic coating agent, as shown in FIG. 4B. Next, the minute recesses 12 are filled with the liquid dispersion 31 of magnetic nanoparticles, as shown in FIG. 4C. Next, dispersing medium of the liquid dispersion 31 is evaporated, so that the magnetic nanoparticles form their aggregate 3 in the minute recesses 12, as shown in FIG. 4D. Next, the magnetic nanoparticles remaining in the form of extremely thin film on the surface excluding the inner surface of the minute recesses are removed. Thus there is obtained the high density magnetic recording medium having the aggregate 3 of magnetic nanoparticles formed in the minute recesses 12, as shown in FIG. 4E.

In the foregoing step, the following method may be employed to form the monomolecular film of the organic coating agent on the substrate surface including the inner surface of the minute recesses. First, the organic coating agent is dissolved in a solvent, such as toluene and hexane. Next, the resulting solution is applied to the substrate surface by dipping (at 20 to 60° C. for 1 to 20 minutes) or spin coating or the like, followed by holding for 1 to 20 minutes.

The minute recesses, which have been coated with the monomolecular film of the organic coating agent, are filled with the liquid dispersion of the magnetic nanoparticles, and dispersing medium of the liquid dispersion is evaporated. As the result of the foregoing procedure, the functional group at one end of the molecular chain reacts with the surface of the magnetic nanoparticles or the functional group of the coupling molecule attached to the surface of the magnetic nanoparticles. In this way, the magnetic nanoparticles bind to the inner surface of the minute recesses. During the foregoing procedure, the liquid dispersion of magnetic nanoparticles binds to the organic coating agent on the substrate surface other than the inner surface of the minute recesses, but the magnetic nanoparticles binding to the external surface of the substrate other than the inner surface of the minute recesses can be easily removed, without the magnetic nanoparticles being removed from the minute recesses, because the magnetic nanoparticles binding to the inner surface of the minute recesses are protected by the minute recesses. To be more specific, the foregoing object may be achieved by washing the substrate in a solvent such that the side in which the minute recesses are formed faces downward. Washing in this manner removes the magnetic nanoparticles in contact with the solvent on the external surface of the substrate other than the inner surface of the minute recesses, because the inside of the minute recesses is filled with air which prevents the entrance of the solvent and thus the magnetic nanoparticles remain unremoved.

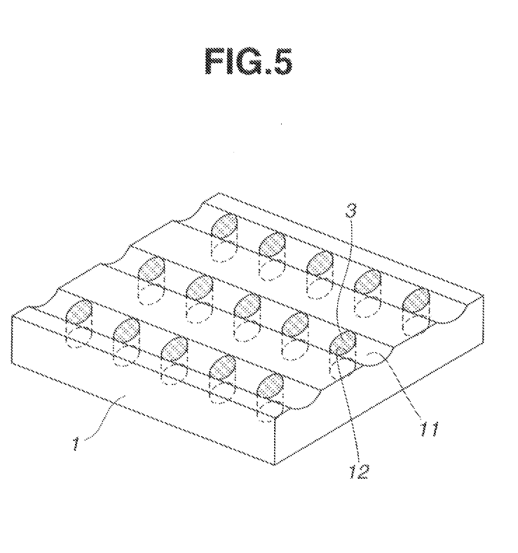

The foregoing method makes it possible to produce the high density magnetic recording medium which is composed of a substrate 1, a plurality of parallel tracks 11 formed in the upper surface of the substrate, a plurality of minute recesses 12 serially formed at approximately equal intervals in each track 11, and the aggregates 3 of magnetic nanoparticles formed individually in the minute recesses 12, as shown in FIG. 5.

The high density magnetic recording medium according to the present invention should preferably have a protective film formed on the substrate in which are formed the aggregates of magnetic nanoparticles. The protective film may be formed from SiO₂ by spin coating (SOG) or application, or from carbon by sputtering.

The high density magnetic recording medium according to the present invention may be incorporated into the magnetic recording device of discrete track type which is regarded as promising in the future. Thus it will be possible to achieve an ultra-high density magnetic recording in excess of 1 Tbit/inch².

### EXAMPLES

The invention will be described below in more detail with reference to the following Example, which is not intended to restrict the scope thereof.

An Si substrate having minute recesses was prepared as shown in FIG. 1. The substrate was dipped still in a toluene solution containing 10 wt % of 3-mercaptopropyl-trimethoxysilane at 60° C. for 10 minutes, so that the inner surface of the minute recesses was coated with a monomolecular layer of 3-mercaptopropyl-trimethoxysilane which achieves binding through the natural oxide film on the Si substrate. The solvent of the solution was evaporated. The minute recesses were given the liquid dispersion of FePt magnetic nanoparticles (5 g/dm³) in hexane by dripping through a pico-litter pipette (“Picopipet” (made by Altair Corporation), followed by natural drying at room temperature, so that aggregates of FePt magnetic nanoparticles were formed. Before and after the aggregates of FePt magnetic nanoparticles were formed, the surface of the substrate was observed under a scanning probe electron microscope (SPM-9600 made by Shimadzu Corporation).

The microscopic observation revealed that the bottoms of the minute recesses changed in contrast, which suggests the presence of FePt magnetic nanoparticles in the minute recesses.

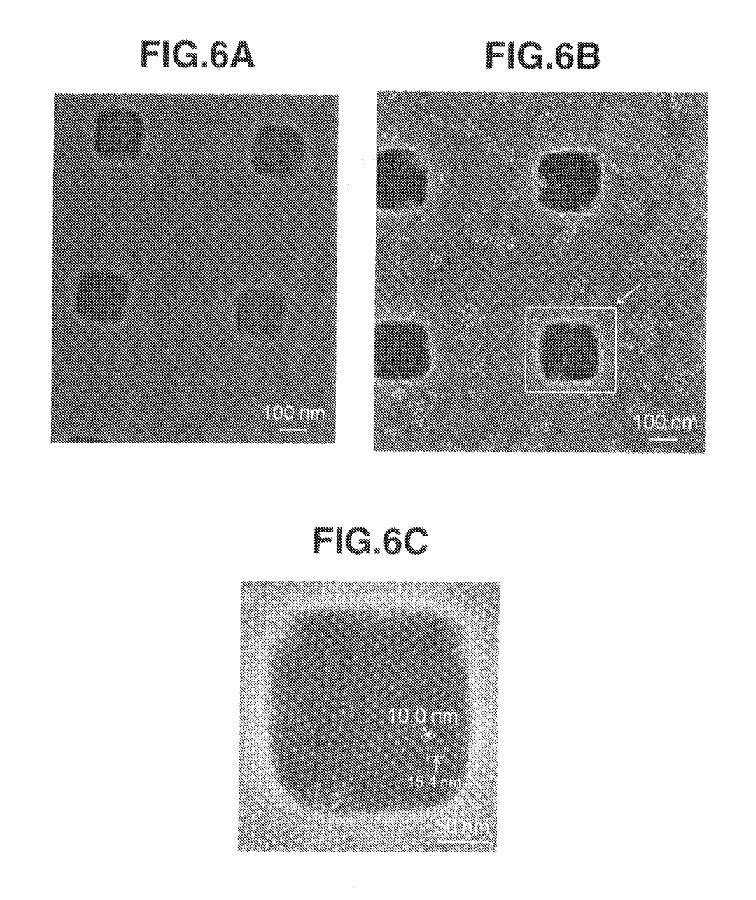

In addition, before and after the aggregates of FePt magnetic nanoparticles were formed, the surface of the substrate was observed under a field emission scanning electron microscope (FE-SEM). The resulting microphotograph is shown in FIGS. 6A to 6C. The microscopic observation revealed that the FePt magnetic nanoparticles (in the form of monolayer) binds to the minute recesses in the substrate, and that each aggregate composes of the nanoparticles dispersed at intervals of about 10 nm.

It was found by X-ray diffraction (XRD) that the FePt magnetic nanoparticles are those of face-centered tetragonal structure (Ll₀), with the (110) plane preferentially oriented. It was also found by X-ray photoelectron spectroscopy (XPS) to examine the surface electron state that the FePt magnetic nanoparticles have a very stable Ll₀ phase. Moreover, measurement by a high-temperature super-conducting quantum interference device (SQUID) revealed that the aggregates of FePt magnetic nanoparticles have a coercive force of 284 kA/m (3.6 kOe).

1. A high density magnetic recording medium comprising aggregates of magnetic nanoparticles arranged in demarcated sections in the surface of a substrate, the substrate comprising a plurality of parallel tracks formed in the surface thereof, each of said tracks comprising minute recesses serially formed therein at approximately equal intervals, and each of said minute recesses comprising an aggregate of magnetic nanoparticles.

2. The high density magnetic recording medium of claim 1, which is produced in such a way that the aggregates of magnetic nanoparticles are formed by casting a liquid dispersion of magnetic nanoparticles into said minute recesses and subsequently evaporating dispersing medium from the liquid dispersion.

3. The high density magnetic recording medium of claim 1, wherein the minute recesses have an opening diameter of 20 to 500 nm and a depth of 10 to 500 nm.

4. The high density magnetic recording medium of claim 1, wherein the magnetic nanoparticles have an average particle diameter of 3 to 20 nm.

5. The high density magnetic recording medium of claim 1, wherein the magnetic nanoparticles have a coercive force not less than 237 kA/m and a remanence ratio not less than 0.5.

6. A manufacturing method of a high density magnetic recording medium comprising aggregates of magnetic nanoparticles arranged in demarcated sections in the surface of a substrate, said method comprising the steps of:
forming a plurality of parallel tracks in the surface of the substrate,
forming a plurality of minute recesses serially at approximately equal intervals in each of said tracks,
casting a liquid dispersion of magnetic nanoparticles into said minute recesses, and
evaporating dispersing medium from the liquid dispersion, thereby forming an aggregate of magnetic nanoparticles in each of said minute recesses.

7. The manufacturing method of a high density magnetic recording medium of claim 6, wherein said tracks are formed by grooving, and said minute recesses are formed individually in said groovelike tracks.

8. The manufacturing method of a high density magnetic recording medium of claim 6, wherein the minute recesses have an opening diameter of 20 to 500 nm and a depth of 10 to 500 nm.

9. The manufacturing method of a high density magnetic recording medium of claim 6, wherein the magnetic nanoparticles have an average particle diameter of 3 to 20 nm.

10. The manufacturing method of a high density magnetic recording medium of claim 6, wherein said method comprising the steps of:
forming a monomolecular layer of an organic coating agent on an inner surface of the minute recesses, said organic coating agent having a functional group at one end of its molecule which binds to the inner surface and another functional group at the other end of its molecule which does not bind to the inner surface but binds to the magnetic nanoparticles; and
bonding the magnetic nanoparticles to the functional group of the other end, thereby binding the magnetic nanoparticles to the inner surface of the minute recesses.

11. The manufacturing method of a high density magnetic recording medium of claim 10, wherein said method comprising the steps of:
forming a monomolecular layer of an organic coating agent on the substrate surface including an inner surface of the minute recesses, said organic coating agent having a functional group at one end of its molecule which binds to the inner surface and another functional group at the other end of its molecule which does not bind to the inner surface but binds to the magnetic nanoparticles;
bonding the magnetic nanoparticles to the functional group of the other end, thereby binding the magnetic nanoparticles to the substrate surface including the inner surface of the minute recesses; and
subsequently removing the magnetic nanoparticles binding to the surface other than the inner surface of the minute recesses.
